(19) United States
(12) Patent Application Publication
(10) Pub. No.: US 2006/0288001 A1
(43) Pub. Date: Dec. 21, 2006

(54) System and method for dynamically identifying the best search engines and searchable databases for a query, and model of presentation of results - the search assistant

(76) Inventors: Rafael Rego Pinto Rodrigues da Costa, Salvador (BR); Daniel Santos Murta de Oliveira, Salvador (BR); Rodrigo Barreto dos Santos, Caminho das Arvores (BR)

Correspondence Address: HOLME ROBERTS & OWEN, LLP, 299 SOUTH MAIN, SUITE 1800, SALT LAKE CITY, UT, 84111, US

(21) Appl. No.: 11/472,181

(22) Filed: Jun. 20, 2006

Related U.S. Application Data
(60) Provisional application No. 60/595,259, filed on Jun. 20, 2005.

(51) Int. Cl. G06F 17/30

(52) U.S. Cl. 707/5

(57) ABSTRACT

The invention is directed to a system and method for dynamically identifying the best search engines and searchable databases for a given query comprising a model where given a query, the more relevant search engines and searchable databases will be retrieved and presented as response to the query.

### RELATED APPLICATION

The present application claims priority under 35 U.S.C. §119 to U.S. Provisional Patent Application No. 60/595,259, filed Jun. 20, 2005, and entitled “Model of Obtaining Information in the World Wide Web by Using a New Concept on Search Engine Tools—The Search Assistant”.

### BACKGROUND OF THE INVENTION

1. Field of the Invention

The present invention refers to a system and method that allows obtaining information from the Internet by using a new concept regarding web search tools, different from conventional search engines and meta search engines.

2. The Relevant Technology

Presently, users can locate information on the Internet using two basic types of search tools: general search engines that cover every area of interest (e.g. Google and Yahoo); and specialized search engines and searchable databases—also known as specialty, specific, or vertical search engines—that focus on a specific niche or area of interest. Some examples of the latter are: HealthLine, for health information only (www.healthline.com); Scirus, for scientific information only (www.scirus.com); and Codase, for source codes only, (www.codase.com) to name a few.

General search engines and Meta search engines crawl and index WebPages relating to every kind of subject. Specialized search engines, however, track a different path, thereby resulting in many advantages.

Specialized search engines and searchable databases are focused by area of interest. As such, instead of searching among a rainfall of possibilities, the user filters the search by simply choosing the search tool, avoiding results that are out of his area of interest. Specialized search engines are more selective about the Internet content, thereby enabling a better quality of the results. Specialized search engines achieve higher updating rates. Specialized search engines present results from the Invisible Web—(also referred to as Deep Web or Hidden Web)—which is the portion of the web not ‘seen’—e.g. indexed—by conventional search engines. In fact, some projections state that all general engines together have not reached anything more than 10% of the Internet content. The remaining 90% is only accessible through the use of a plurality of specialized engines and searchable databases.

A complete search requires consideration of the highest number of engines as possible. There are currently more than 200,000 search engines available on-line, such as general search engines and meta engines, specialized search engines, web directories and databases to name a few. This number only increases from the current staggering number, which creates problems.

Two potential issues arise from the increase in numbers: how can Internet users know which search engines are best suited to their search, and what are the best search engine choices for each search? The problem is not only knowing the search engines, which is humanly impossible due to the huge number of possibilities, but also knowing when to use them according to the context.

Patents exist that propose a meta search engine system capable of interacting with multiple sources, such as for example U.S. Pat. No. 6,999,959. Presently, all known meta search engines are basically an apparatus that send the user's queries to a plurality of pre-defined search engines and then compiles the results (documents) obtained from each of these search engines into a single ranked list. The documents are then presented as results. There are currently no meta search engines that focus on either dynamically retrieving search engines and searchable databases as the final result to a query (search), or meta-searching thousands of engines and databases, varying sources according to the query.

U.S. Pat. No. 6,771,569 describes a method for automatically selecting databases, aimed at improving the efficiency of data capture and management systems. The method comprises a sorting search engine for a given query, but does not include elements to facilitate internet users to browse through results, such as pointers to search engines' pages of results to the query. Moreover, the method demonstrates some limitations such as the non-existence of an offline process to retrieve Search Engines, either to present them as results or to select the most relevant ones to be consulted (queried), what would enable to work with a much higher (almost unlimited) number of simultaneous sources even with limited operating resources. The method also does not include mechanisms to automatically insert new search engines to the process. Additionally it can be said that the relevance of each search engine to the query, which is measured through the average score of some results inside each search engine, is based on a limited set of variables, resulting in a low-efficiency relevance algorithm.

It is therefore desirable to create a System that presents Internet Users with search engines and searchable databases as the final result to a query. Such an idea would enable many advantages and a highly-effective fully distributed search model.

### SUMMARY OF THE INVENTION

A new model of obtaining and presenting information in the World Wide Web is presented in the form of a system and method for dynamically identifying the best search engines and searchable databases for a given query, and its model of presentation of results. Aspects of the system and method extend the reach of research on the Internet, thereby dynamically organizing the numerous high-quality search engines and databases in a single place, and assisting users in using them.

This system, method and model of presentation regards novel themes and important upgrades to the prior art of dynamically interacting with searchable databases. Summarily, this method of retrieving information works as follows: a) the user types his query in the system's search field; b) after selecting the “Search” button, a result list is returned to the user, presenting the most adequate search engines and searchable databases to find the keywords typed, ordered by relevance, and together with a brief descriptive and categorization of each source, and; c) by clicking on a specific search engines' hyperlink, the user is redirected to the page of results each engine has to the searched keywords.

In one aspect of the invention, the Search Assistant comprises a system that automatically identifies search engines and searchable databases among the WWW, learns how to interact with them, extracts descriptive and categorization information, and performs a representative index of each searchable database.

So, given a user's particular query, the system (1) consults the representative index; (2) measures relevancies; and (3) determines which are the most adequate search engines and databases to that query. Then, two options are possible: it can deliver results immediately, based on that first ranking, referred to herein as an Offline Ranking Process, or it can consult (query) the N first engines and databases of the ranking performed by the Offline Ranking Process. This process of consulting (querying) engines and databases is referred to as an Online Ranking Process. Defined generally, an Online Ranking Process comprises capturing the relevant information of each engine to a given query to measure the relevance of each engine to that query; and thereafter arranging a list of results, also presenting the most adequate search engines and searchable databases to the query. A third method of arranging the list of results—i.e., of ranking search engines and databases to a query—is to combine the scores assigned to each engine by both the Offline and Online Ranking Processes. Given a list of results, once the user chooses and clicks on a specific result (search engine), the Search Assistant displays its page of results to the given query dynamically, and the user is re-directed to this page.

The model presented and described here has many advantages in functionality and efficiency if compared to conventional approaches, especially to common meta search engines. By not focusing on displaying merged results, as common meta search engines do, but on finding the potential search engines and searchable databases for every user's query, and presenting them as results, the Search Assistant can entirely aggregate work from all sources, reaching a more effective distributed search, and making technically viable a large scale operational model, and a complete coverage of the online information.

Other features are inherent in the disclosed system and method or will become apparent to those skilled in the art from the following detailed description of embodiments and its accompanying drawings.

### BRIEF DESCRIPTION OF THE DRAWINGS

The invention aspects will be better understood by referring to the following detailed description, which should be read in conjunction with the accompanying drawings, in which:

FIG. 1 illustrates how the Search Assistant builds its operating database;

FIG. 2 presents a flowchart depicting an Offline Ranking Process to perform the retrieval of the best Search Engines and Searchable Databases to a query;

FIG. 3 illustrates a flowchart depicting a Combined Ranking Process, associating both offline and online methods, to perform the retrieval of the best Search Engines and Searchable Databases to a query;

FIG. 4 illustrates a model of the page of results of the Search Assistant; and

FIG. 5 illustrates an alternative model of the page of results of the Search Assistant.

### DETAILED DESCRIPTION OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

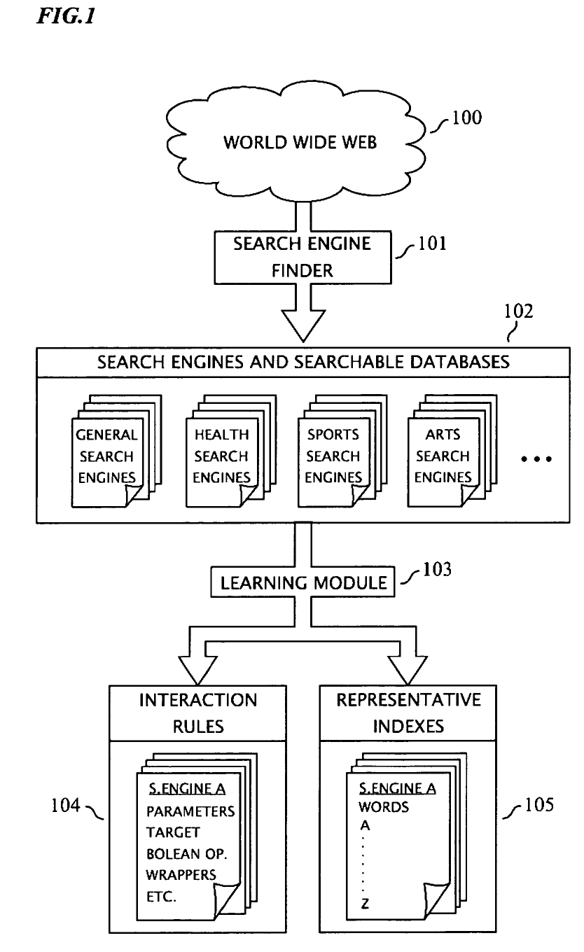

The block diagram of FIG. 1 illustrates how a Search Assistant builds its operating database. In order to find search engines, the system aggregates a special crawler 101, here named search engine finder, which continuously seek the World Wide Web 100 for search engines and searchable databases 102. The special crawler 101 uses well known methods in order to reach different WebPages, but instead of indexing all pages, it is only addressed to identify pages with search fields, in short, pages where HTML Tags such as <form> and <input> can be found, and where there are evidences that they are related to a search field, e.g., containing an attribute named search, etc. The identified search engines and searchable databases 102 are then forward to the learning module 103, where a series of operations are made in order to automatically discover and store the interaction rules 104, i.e., the information needed in order to dynamically interact with each database. So, a set of queries, comprehending “possible queries” (queries that most likely produce valid results), and “impossible queries” (queries that most likely produce zero result pages), are automatically sent to each search engine, by the learning module 103. All results are analyzed in order to capture interaction rules 104 for each search engine. Examples of interaction rules 104 are: search methods (POST, GET), target URL (URL of the page of results), Boolean operators (All words/Any Words/Phrase Match), wrappers for results extraction, etc. In other words, all information needed in order to automatically send a request to a search engine and understand its page of results. Once the interaction rules 104 for a given search engine are known, the learning module 103 starts querying this search engine with sample queries in order to capture their results and index them, performing a representation of its database. This way, the learning module 103 performs and stores a representative index 105 for each database, i.e. an index of words that best represent each search engine. The sample queries used in order to perform the representative index 105 for each database may be words from a static repository—such as a list of words—or it can also be words from a dynamically generated repository—such as words found during the indexation process.

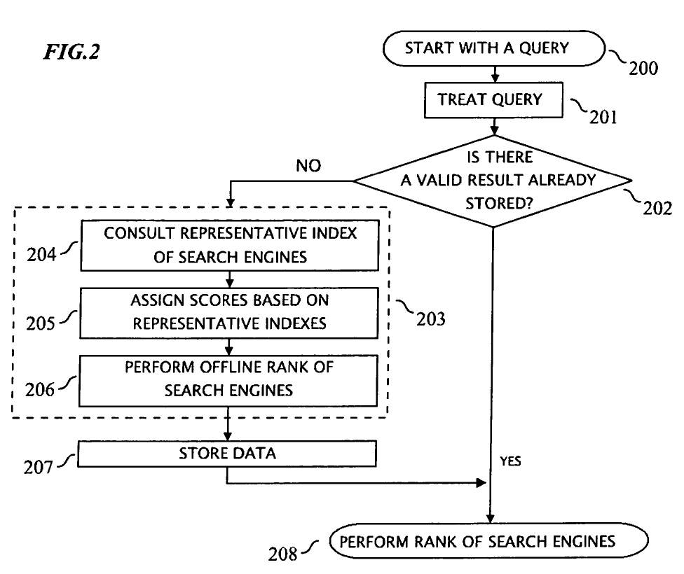

FIG. 2 presents a flowchart depicting an Offline Ranking Process to perform the retrieval of the best search engines and searchable databases to a query. The process starts when a given query 200 is received. Treat the query 201 is the next step. This query treatment has the main objective of interpreting key-words defining strings, if necessary excluding stop words, performing stemming words, setting correlated words, understanding the association between words (All words search/Any words search/Phrase match search/etc.), setting capital or small letters when it is necessary, etc. Once the key-words are treated, the system may check its databank 202 to see if there is already a result list stored to the specific key-words, in another words, if the query have been made before and its time expiration still valid. So, once the systems check its databank 202, if there is already sufficient valid data stored, the process follows to the performance of the output rank of search engines 208; if not, those data needs to be raised, and the method follows to the Offline Ranking Process 203. The Offline Ranking Process 203 is composed by three main processes: First proceeds the offline consult 204 to the representative index 105 of each search engine, identifying the search engines and searchable databases 102 that brings reference to the searched key-words. Second, the offline scores 205 are assigned, to each search engine and database, based on the analysis of the elements uploaded from the representative index 105 in the offline consult 204. Such elements may include inverted files (index) common elements, such as word hits or term frequencies, document frequencies, inverted document frequencies, collection frequencies, inverted collection frequencies, words positioning, etc., and may also make use of additional techniques such as the use of thesaurus and complementary dictionaries in order to help determining which search engines and searchable databases 102 are the most relevant to the query. Third, once scores are assigned, the search engines and searchable databases are ranked according to their scores, being the highest scored engines placed in the top of the list. This list is the Offline Rank of search engines 206. The data raised to perform the Offline Rank of search engines 206 is stored 207 in the system's databank (or another way of persistency or data repository), so once the same key-words are searched again in the future, the results can be identified once the system check its databank 202. Follows the performance of the output rank of search engines 208, the Search Assistant's page of results.

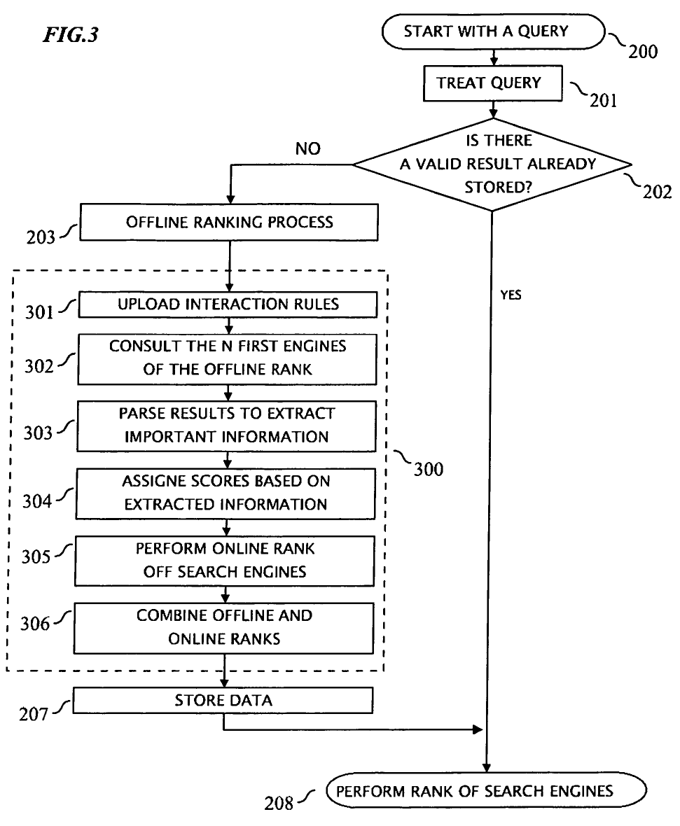

FIG. 3 depicts the Combined Ranking Process, where the Offline Ranking Process 203 is associated with an Online Ranking Process 300 in order to perform a more comprehensive and precise output rank of search engines 208. In this case, after the Offline Ranking Process 203 is performed, proceeds the Online Ranking Process 300. It can be said that consulting many engines simultaneously is a resource consuming task. Therefore the Online Ranking Process 300 will consult a limited number “N” of sources. So the Offline Rank of search engines 206 is used as a filtering list, being the “N” first engines selected to pass through the online consult 302. Before performing the consults, the system needs to upload search parameters 301 from the interaction rules 104 database, in order to correctly send the key-words to each Search Engine, maintaining the search preferences (ex: All words search/Any words search/Phrase match search/etc.), and to correctly parse each search engines' page of results to the query 303, and eventually their results, for important information, such as word hits, term frequency, string matches, hierarchical analysis (title, descriptive, etc.), etc., in resume, all information needed in order to assign the online scores 304 to each engine. Once online scores 304 are assigned, the search engines and searchable databases are ranked according to these scores, being the highest scored engines placed in the top of the list. This list is the Online Rank of search engines 305. Combining the offline scores 205 with the online scores 304, i.e., combining the Offline Rank of search engines 206 with the Online Rank of search engines 305, we can get to the Combined Rank of search engines 306, resulting on a more precise output rank of search engines 208.

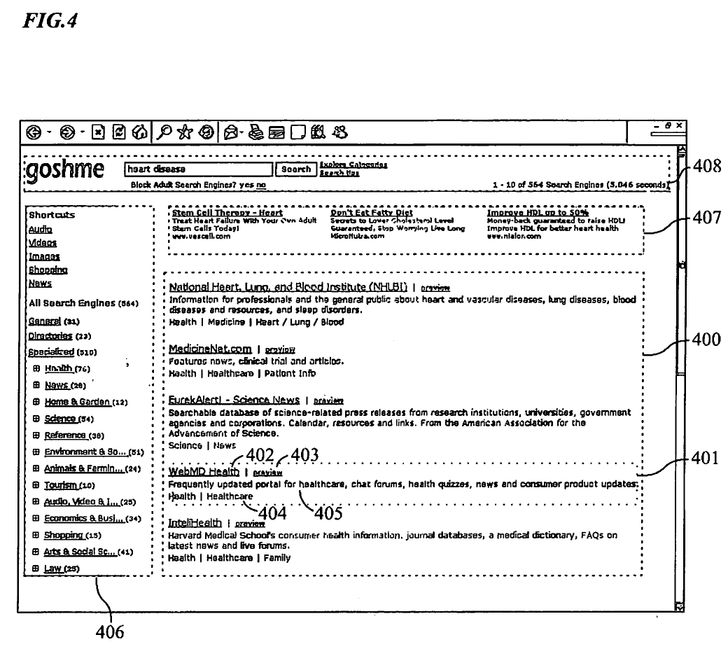

FIG. 4 illustrates a model of the end-user's page of results, basically bringing output rank of search engines 208 formatted as the results list 400. The results list 400 contains one or more search engines and searchable databases 102, each one as a single result 401. The single results 401 come ordered by relevance according to the performed Offline Rank of search engines 206 or the Combined Rank of search engines 306. Each result 401 brings the search engine's title 402 containing the hyperlink to the search engine's page of results to the query. So once the user chooses one particular result 401 he can click on the search engine's title 402 and the Search Assistant will make use of the interaction rules 104 in order to request the page of results to the query and re-direct the user to it. Each result 401 may also bring additional information in order to assist users in making good choices, such as descriptive of each search engine 405, categorization and classification 404, and additional information. Each result 401 may also include a preview feature 403 in order to enable viewing each search engines' page of results without leaving the Search Assistant's results page. The sample results page of the Search Assistant may also include a filter per category 406, allowing to filter results per area of interest, commercial spaces 407, allowing to publish advertisements, and additional elements 408 such as search field 300 and search button 301, and also additional filters, new search options, etc.

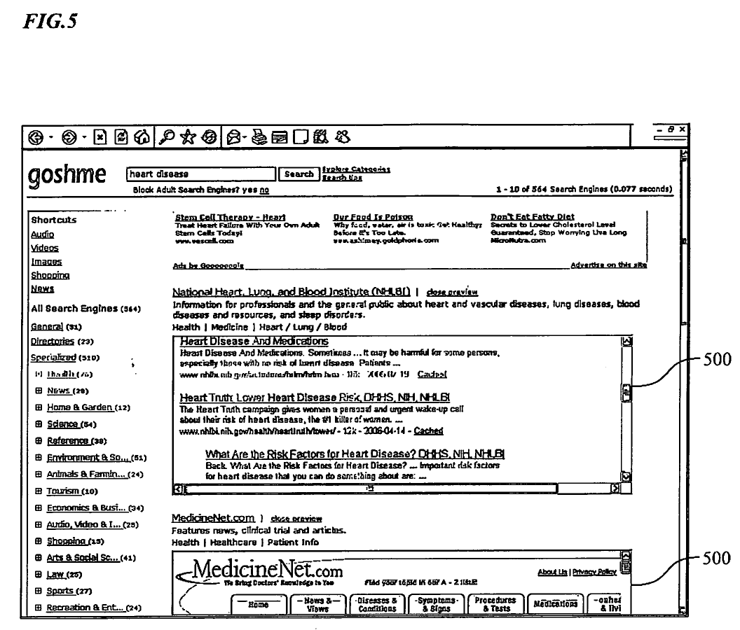

FIG. 5 illustrates an alternative model of the page of results of the Search Assistant, where the preview feature 403 is on, allowing users to view each search engines' results in a frame 500, enabling browsing through results without leaving the Search Assistant's results page.

Although the invention has been described in terms of certain preferred embodiments, it may be embodied in other specific forms without changing its spirit or essential characteristics. The embodiments described are to be considered in all respects only illustrative and not restrictive and the scope of the invention is, therefore, indicated by the appended claims rather than by the foregoing description. All changes which come within the meaning of equivalency of the claims are to be embraced within their scope.

What is claimed is:

1. A method for dynamically identifying search engines or searchable databases for a given query comprising:
performing a query treatment, said query treatment including at least one step selected from a group consisting of:
interpreting key-words defining strings,
performing stemming words,
setting correlated words,
understanding the association between words, and
setting capital or small letters when it is necessary;
checking a stored list to determine if there is already a result list stored related to said key-words,
and, if there is valid result list stored in said stored list, skipping an offline ranking
process and proceeding to an output ranking of search engines and searchable databases;
performing said offline ranking process, in which said search engines and searchable databases
are retrieved based on representative indexes without performing any online consult;
storing the data such that when the same key-words are searched again in the future, the results
can be immediately retrieved; and
output ranking of said search engines and searchable databases as a page of results.

2. The method of claim 1, wherein said offline ranking process further comprises an offline consult to the representative index of each search engine by:
identifying a plurality of search engines and searchable databases that brings reference to the searched key-words;
assigning offline scores to each search engine and database based on the analysis of the elements uploaded in the offline consult to the representative index; and
ranking the search engines and searchable databases according to their scores, being the highest scored engines placed in the top of the list.

3. The method of claim 2, wherein said elements are chosen from the group consisting of inverted files (index) common elements such as word hits or term frequencies, document frequencies, inverted document frequencies, collection frequencies, inverted collection frequencies, words positioning or additional techniques such as the use of thesaurus and complementary dictionaries in order to help determining which search engines and searchable databases are the most likely to address the query searched.

4. The method of claim 1, wherein said representative index comprises a summary of the content of each search engine and searchable database built by querying each one with sample queries and by building an inverted file based on a sample group of documents of each search engine and searchable database.

5. The method of claim 4, wherein said sample queries used in order to request the pages of results, extract documents, and build the representative index for each search engine and searchable database comprise words from a static repository.

6. The method of claim 4, wherein said sample queries used in order to request the pages of results, extract documents, and build the representative index for each search engine and searchable database comprise words from a dynamically generated repository.

7. The method of claim 4, wherein said representative index associated with said thesaurus and with a previous categorized and classified repository of words can generate automated classification of the content and enable to automatically categorize each Search Engine and Searchable Databases into areas of knowledge.

8. The system and method of claim 1, wherein said offline ranking process is combined with an online ranking process, in order to reach a more comprehensive output rank of search engines.

9. The method of claim 8, wherein an offline rank of search engines is used as a filtering list, being the “n” first engines selected to pass through online consult, so as to upload search parameters from the called interaction rules database, in order to format the query to every search engine, maintaining the search preferences, and parse each search engines' page of results to the query, and eventually their results, for important information, such as word hits, term frequency, string matches, hierarchical analysis, in order to assign called online scores, wherein online scores can also make use of additional relevance elements such as hyperlinks networking, user's implicit feedback, and other statistics of use and once online scores are assigned, the search engines and searchable databases are ranked according to these scores, being the highest scored engines placed in the top of the list, wherein said list is an online rank of search engines, wherein combining the said offline scores with the online scores to determine a combined rank of search engines.

10. The method of claim 9, wherein said interaction rules database comprises the parameters needed in order to send and receive pages of results to every Search Engine and Searchable Databases.

11. The method of claims 9, wherein said output rank brings hyperlinks pointing to the URL of the page of results each search engine and searchable database has to the given query, wherein said URL is dynamically generated every time a user requests it, comprising:
a user clicking on a particular search engine or searchable database;
uploading search parameters from said interaction rules database;
formatting the URL of the page of results to the query; and
redirecting user to said URL of the page of results of the clicked search engine.

12. The method of claim 10, wherein said parameters are chosen from a group consisting of search methods (POST, GET), target URL (URL of the page of results), Boolean operators (All words/Any Words/Phrase Match/Near/Not), wrappers for results extraction and HTML hierarchic structure.

13. The method of claim 12 further comprising building an operating database to extract said interaction rules and to perform said representative index.

14. The method of claim 12, wherein said building said operating database comprises:
using a special crawler configured to be a search engine finder to find search engines and searchable databases to be set to operate in the said search assistant;
using the search engine finder to continuously seek the world wide web for search engines and searchable databases;
finding pages with search fields or pages where html tags such as < form> and <input> can be found, and where there are evidences that they are related to a search field, wherein such evidence can be an attribute named search, research, find, seek, fetch, or any other similar word, in english or in any other language;
forwarding said identified search engines and searchable databases to the called learning module having a series of operations to automatically discover and store the said interaction rules;
automatically sending a set of queries comprising possible queries and impossible queries to each search engine;
analyzing results in order to capture said search parameters; and
storing said representative index for each database by querying of a search engine with sample queries in order to capture results and index them, and thereafter performing a representation of its database.

15. The method of claim 9 wherein said output rank of search engines and searchable databases is based on the said online ranking process, comprising the use of the said online scores in order to perform the ranking of search engines and searchable databases.

16. The method of claim 9 wherein said output rank of search engines and searchable databases is replaced by an output rank of documents found inside those engines, said output rank of documents comprising the results each search engine and searchable database brings to the searched query.

17. The method of claim 16, wherein said output rank of documents comprises:
within said online ranking process, assigning scores to the results found inside the page of results of each search engine and searchable database, such scores being based on the content of each document and on the scores of the search engine or searchable database the document belongs to, wherein said relevance factor comprises a named document score; and
building a list merging said documents found inside all search engines and searchable databases by placing these documents ordered by said document scores.

18. The method of claim 1, wherein said output rank brings hyperlinks pointing to the URL of the page of results each search engine and searchable database has to the given query, wherein said URL is dynamically generated every time a user requests it, comprising:
a user clicking on a particular search engine or searchable database;
uploading search parameters from said interaction rules database;
formatting the URL of the page of results to the query; and
redirecting user to said URL of the page of results of the clicked search engine.

19. The method of claim 18, wherein said page of results each search engine and searchable database has to the given query is presented in a frame inside the search assistant's page of results to the query, comprising:
user clicking on a particular search engine or searchable database;
uploading search parameters from said interaction rules database;
formatting the URL of the page of results to the query; and
opening said URL of the page of results of the clicked search engine in a frame inside the search assistant's page of results.

20. The method of claim 14, wherein said output rank brings hyperlinks pointing to the URL of the page of results each search engine and searchable database has to the given query, wherein said URL is dynamically generated every time a user requests it, comprising:
a user clicking on a particular search engine or searchable database;
uploading search parameters from said interaction rules database;
formatting the URL of the page of results to the query; and
redirecting user to said URL of the page of results of the clicked search engine.
